(19) United States
(12) Patent Application Publication
(10) Pub. No.: US 2025/0342026 A1
(43) Pub. Date: Nov. 6, 2025

(54) DYNAMICALLY UPGRADING A MODEM

(71) Applicant: Charter Communications Operating, LLC, St. Louis, MO (US)

(72) Inventors: Ajay G. Sriram, Parker, CO (US); Isaiah Connell, St. Charles, MO (US)

(21) Appl. No.: 18/653,517

(22) Filed: May 2, 2024

(51) Int. Cl. G06F 8/65; G06F 8/71; G06F 11/14

(52) U.S. Cl. CPC G06F 8/65; G06F 8/71; G06F 11/1415

(57) ABSTRACT

A computing system having one or more computing devices provides a configuration file identifier to a cable modem. Subsequently, the computing system provides the configuration file to the cable modem, and the configuration file includes a firmware file identifier that does not match an existing firmware file identifier of any existing firmware file provided by the computing system to cable modems. Subsequently, the computing system receives a firmware file request, which includes the firmware file identifier, from the cable modem and, subsequently, determines whether a firmware of the cable modem is outdated. The computing system may provide an updated firmware file to the cable modem if the firmware file of the cable modem is outdated.

### BACKGROUND

A service provider that provides data services, such as Internet access, to subscribers, such as residences and businesses, may have hundreds or thousands of aggregation devices, such as cable modem termination systems (CMTSs), located throughout a large geographic area. Each aggregation device may communicate with hundreds or thousands of customer premises equipment (CPE), such as cable modems, which are physically located in the premises of the subscribers. A subscriber that obtains network access or other services (e.g., cable services) from the service provider can receive the network access and/or other services through a cable modem on the customer's premises.

### SUMMARY

The examples disclosed herein dynamically upgrade and update a cable modem's firmware during the boot process.

In one implementation, a method is provided. The method includes providing, by a computing system comprising one or more computing devices, a configuration file identifier to a cable modem. The method further includes, subsequent to providing the configuration file identifier to the cable modem, providing, by the computing system, a configuration file to the cable modem, the configuration file comprising a firmware file identifier that does not match an existing firmware file identifier of any existing firmware file provided by the computing system to cable modems. The method further includes, subsequent to providing the configuration file to the cable modem, receiving, by the computing system from the cable modem, a firmware file request comprising the firmware file identifier. The method further includes, in response to receiving the firmware file request from the cable modem, determining, by the computing system, whether a firmware of the cable modem is outdated based on data associated with the cable modem. The method further includes, in response to determining the firmware of the cable modem is outdated, providing, by the computing system, an updated firmware file to the cable modem.

In another implementation, a method is provided. The method includes receiving, by a cable modem, a configuration file identifier from a computing system, the configuration file identifier corresponding to a configuration file for the cable modem. The method further includes, subsequent to receiving the configuration file identifier from the computing system, sending, by the cable modem to the computing system, a configuration file read request based on the configuration file identifier. The method further includes, subsequent to sending the configuration file read request to the computing system, receiving, by the cable modem from the computing system, the configuration file, the configuration file comprising a unique firmware file identifier. The method further includes determining, by the cable modem, the unique firmware file identifier does not match an existing firmware file identifier of any existing firmware file provided by the computing system. The method further includes, in response to determining the unique firmware file identifier does not match the existing firmware file identifier of any existing firmware file, sending, by the cable modem, a firmware file request to the computing system.

In another implementation, a computing system is provided. The computing system includes one or more computing devices operable to provide a configuration file identifier to a cable modem. The one or more computing devices are further operable to, subsequently, provide a configuration file to the cable modem, the configuration file comprising a firmware file identifier that does not match an existing firmware file identifier of any existing firmware file provided by the computing system to cable modems. The one or more computing devices are further operable to, subsequently, receive a firmware file request comprising the firmware file identifier from the cable modem. The one or more computing devices are further operable to, in response to receiving the firmware file request, determine whether a firmware of the cable modem is outdated based on data associated with the cable modem. The one or more computing devices are further operable to, in response to determining the firmware of the cable modem is outdated, provide an updated firmware file to the cable modem.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram suitable for dynamically upgrading a modem according to one implementation;

FIGS. 2A-2C are sequence diagrams illustrating messages communicated between and actions taken by certain components illustrated in FIG. 1 for dynamically upgrading a modem according to one implementation;

FIG. 3 is a flowchart of a method for dynamically providing updated firmware files to a cable modem according to one implementation;

FIG. 4 is a flowchart of a method for dynamically configuring a cable modem according to one implementation; and

FIGS. 5A-5B are flowcharts of the method of FIG. 4 for dynamically configuring the cable modem according to one implementation.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

CPEs, such as cable modems, include stored firmware file(s) which allow the CPEs to operate. More particularly, firmware for a cable modem refers to the software that is installed in the hardware of the cable modem that controls the cable modem's operational functionality, such as connectivity (upstream and downstream), network management, data transmission, etc. For instance, firmware may serve as an operating system for the cable modem and may implement various network protocols (e.g., Data Over Cable Service Interface Specification (DOCSIS)). Firmware may also store and manage configuration settings for the cable modem, including various network parameters such as, by way of non-limiting example, IP address(es), subnet mask(s), default gateway address(es), DNS server address(es), and/or the like.

Service providers, manufacturers, and/or the like often release firmware updates that improve the performance, security, and/or other network parameters. Due to the crucial role the cable modem plays in a service provider to customer datalink, timely and efficient firmware upgrades are important for maintaining peak performance of the cable modem. Some cable modems require manual firmware updates, either by the customer, a service technician, or the like. On the other hand, some cable modems can be updated over the service provider's network and/or without user intervention (e.g., DOCSIS configuration file, SNMP initiation). However, these firmware upgrade methods and processes can be inefficient, untimely, and/or unsecure. As one example, cable modems are informed, typically by the service provider, that a firmware update and/or upgrade is available and, once notified, the cable modem proceeds with trying to obtain the upgraded and/or updated firmware files.

The embodiments disclosed herein provide a solution to these problems by providing for dynamic firmware upgrading during the cable modem's boot process. As will be discussed in greater detail below, the service provider computing system provides unique firmware file identifiers—which differ from any current or past actual firmware file—to a cable modem during the boot process (e.g., in a configuration file). The cable modem compares the unique firmware file identifier to the firmware file identifier of the current firmware implemented on the cable modem, and because the unique firmware file identifier does not match the firmware file identifier of the current firmware, the cable modem determines that upgraded firmware is available. The cable modem then requests an upgraded firmware file from the service provider computing system during the boot process. The computing system can then determine whether in fact upgraded firmware is available. If so, the computing system is able to provide the upgraded firmware file to the cable modem during the boot process itself. Alternatively, if an upgrade is not needed, the cable modem may proceed with its configuration processes, thereby preserving computing resources and saving time that would have otherwise been spent upgrading the cable modem's firmware.

The present disclosure provides a number of technical effects and benefits, including improvements to computing technology. As one example, the present disclosure may ensure update-related performance improvements are pushed to the cable modems in a timely and efficient manner. By providing firmware updates during the boot process, the present disclosure may rapidly deploy firmware upgrades, thereby enhancing and improving the overall performance of the cable modem and reducing or eliminating manual actions that might otherwise be necessary. Moreover, the embodiments disclosed herein provide scalable provisioning and upgrading of different cable modems with differentiated features from different manufacturers, thereby providing for dynamic and efficient system-level maintenance.

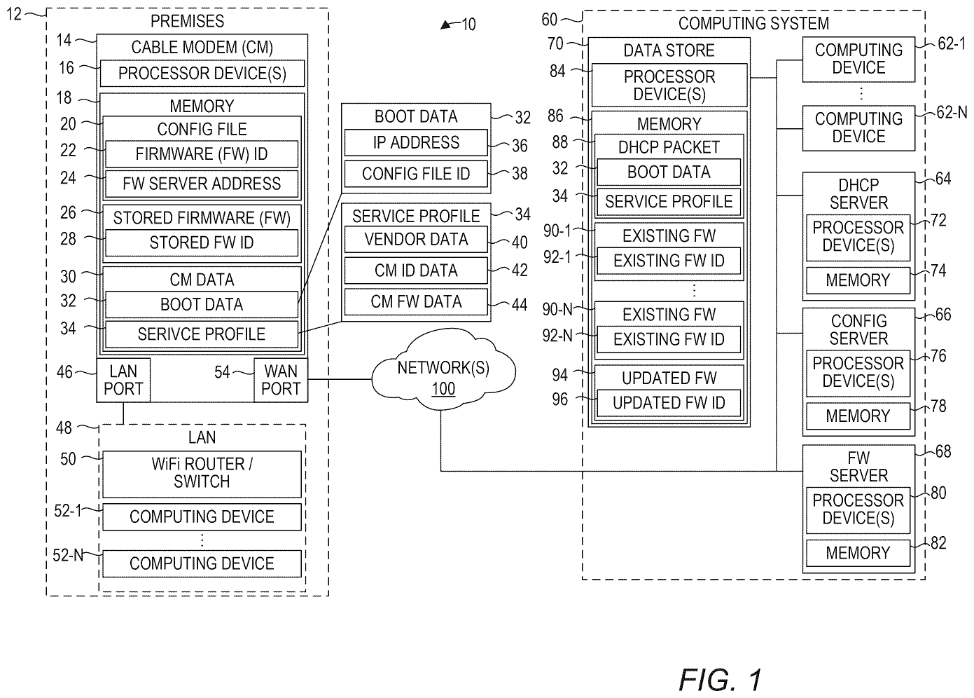

FIG. 1 is a block diagram of an environment 10 suitable for implementing one or more of the methods and/or processes disclosed herein, such as dynamically upgrading an access device (e.g., cable modem 14) according to some embodiments. The environment 10 includes a customer premises 12. The customer premises 12 is associated with a customer. For instance, the customer premises 12 may be a customer's home, business, and/or other premises. The customer premises 12 may include an access device, such as a modem, such as a cable modem 14 (e.g., a D4.0 cable modem). It should be understood that the customer premises 12 may include any suitable customer premises equipment (CPE) device without deviating from the scope of the present disclosure.

As shown, the cable modem 14 includes processor device(s) 16 and a memory 18. The processor device(s) 16 may include any computing or electronic device capable of executing software instructions to implement the functionality described herein. The memory 18 can be or otherwise include any device(s) capable of storing data, including, but not limited to, volatile memory (random access memory, etc.), non-volatile memory, storage device(s) (e.g., hard drive(s), solid state drive(s), etc.).

The memory 18 may store a configuration file 20 for the cable modem 14. As discussed below, the cable modem 14 may initiate a boot process and configure attributes of the cable modem 14 based on the configuration file 20. More particularly, the cable modem 14 may receive the configuration file 20 from a computing system associated with a service provider computing system (e.g., computing system 60). The configuration file 20 may include a firmware file identifier 22 and a firmware server address 24. In some instances, the firmware file identified by the firmware file identifier 22 may correspond to a stored firmware file 26 of the cable modem 14 (e.g., the firmware file identifier 22 matches a firmware file identifier associated with the stored firmware file 26 (hereinafter “stored firmware file identifier 28)). In some instances, the firmware file identified by the firmware file identifier 22 may not correspond to the stored firmware file 26 (e.g., the firmware file identifier 22 does not match the stored firmware file identifier 28). In such instances, the cable modem 14 may send a firmware file request to the computing system 60 (e.g., based on the firmware server address 24) to receive the firmware file identified by the firmware file identifier 22 in the configuration file 20.

As noted above, the memory 18 may include the stored firmware file 26, which corresponds to a current firmware version running on the cable modem 14. The stored firmware file 26, which includes the stored firmware file identifier 28, provides necessary instructions and functionality for the cable modem 14 to operate. By way of non-limiting example, the stored firmware file 26 may include instructions and functionality for establishing connections with an associated service provider network (e.g., computing system 60), managing network settings, and/or facilitating data transmission between devices (e.g., computing devices 52-1-52-N) on an associated local area network (LAN) 48 and/or a wide area network (e.g., network 100).

The memory 18 may store a variety of data associated with the cable modem 14 (hereinafter “cable modem data 30”), such as boot data 32 and service profile data 34 associated with the cable modem 14. More particularly, the boot data 32 may include an IP address 36 provided by the computing system 60. The boot data 32 may further include a configuration file identifier 38 associated with the configuration file 20 stored in memory 18. Furthermore, the service profile data 34 may include vendor data 40 associated with a vendor of the cable modem 14. The service profile data 34 may further include cable modem identification data 42 associated with the cable modem 14, such as, by way of non-limiting example, a model number of the cable modem 14, a subscribed data rate associated with the cable modem 14, and/or the like. The service profile data 34 may further include cable modem firmware data 44, which may correspond to the current firmware version (e.g., stored firmware file 26) of the cable modem 14.

The cable modem 14 may include a LAN port 46 that is operable to provide access to the LAN 48. The LAN 48 may include a Wi-Fi router or switch 50 operable to connect one or more computing devices 52-1-52-N in the LAN 48. In this way, each of the computing devices 52-1-52-N may receive network services or other services from a service provider (e.g., computing system 60) through the cable modem 14. For instance, the cable modem 14 may be operable to provide network access and data services at a speed tier defined by the service profile data 34 (e.g., subscribed data rate).

The cable modem 14 may be operable to access other networks 100, such as a wide-area network (WAN) (e.g., a hybrid fiber-coaxial network and/or distributed access architecture (DAA) network), through a network interface (e.g., WAN port 54). For instance, in some implementations, the WAN port 54 may be a coaxial interface operable to communicate over a coaxial data line. The WAN port 54 may include RF front-end circuitry that does suitable demodulation on data received via the network 100, such as from a cable management termination system (CMTS) (not illustrated), and suitable modulation for data sent by the cable modem 14 to the CMTS. In addition, the cable modem 14 may include or be communicatively coupled to diplexers, splitters, and combiners that enable the cable modem 14 to operate in different frequency plans as specified in the DOCSIS 4.0 PHY specification. In addition, the cable modem 14 may include the RF front-end circuit for the cable modem 14. This RF front-end circuit demodulates the downstream DOCSIS signals for processing by the cable modem 14 and modulates the upstream DOCSIS signals from the cable modem 14 for transmission via the WAN port 54.

The environment 10 further includes a computing system 60. In some implementations, such as that depicted in FIG. 1, the computing system 60 may be a computing system that includes multiple computing devices, such as one or more computing devices 62-1-62-N, one or more server computing devices (e.g., DHCP server 64, configuration server 66, firmware server 68), one or more aggregation devices, such as CMTSs, and a data store 70. Alternatively, in some implementations, the computing system 60 may be one or more computing devices (e.g., computing device 62-1) within a computing environment that includes multiple distributed devices and/or systems. It should be understood that the computing system 60 is depicted with multiple computing devices and multiple server computing devices for purposes of illustration and discussion.

As shown, the computing system 60 may include one or more server computing systems, such as, by way of non-limiting example, a dynamic host configuration protocol (DHCP) server 64, one or more Trivial File Transfer Protocol (TFTP) servers (e.g., a configuration server 66, a firmware server 68), and the like. For instance, the DHCP server 64 may be a server computing device that is communicatively coupled to the cable modem 14 over the network 100. The DHCP server 64 may include processor device(s) 72 and a memory 74, which may be similar to any of the processor device(s) and/or memories described herein. The configuration server 66 may also be a server computing device that is communicatively coupled to the cable modem 14 over the network 100. The configuration server 66 may include processor device(s) 76 and a memory 78, which may be similar to any of the processor device(s) and/or memories described herein. The firmware server 68 may also be a server computing device that is communicatively coupled to the cable modem 14 over the network 100. The firmware server 68 may include processor device(s) 80 and a memory 82, which may be similar to any of the processor device(s) and/or memories described herein. It should be understood that the computing system 60 may include any suitable server computing device, such as, by way of non-limiting example, Automatic Configuration Servers (ACS), SNMP servers, Speed Test servers, and/or the like.

The computing system may further include a data store 70 that is communicatively coupled with the server computing devices (e.g., DHCP server 64, configuration server 66, firmware server 68) and/or the computing devices 62-1-62-N of the computing system 60. In some implementations, the data store 70 may also be communicatively coupled with the cable modem 14 over the network 100. The data store 70 may include processor device(s) 84 and a memory 86, which may be similar to any of the processor device(s) and/or memories described herein.

As described herein, in some examples, the computing system 60 is operable to provide data to and dynamically update the cable modem 14. In some implementations, the computing system 60 is operable to dynamically determine whether the stored firmware file 26 of the cable modem 14 is outdated during the boot process (e.g., startup) of the cable modem 14. The term “boot process” as used herein refers to the initial processing of the cable modem after being powered on or instructed to reboot and prior. The boot process includes registration with an upstream CMTS and obtaining an IP address. In such instances where the stored firmware file 26 of the cable modem 14 is outdated, the computing system 60 may provide updated firmware file data to the cable modem 14 over the network 100.

As one illustrative example, during a boot process, the cable modem 14 may send a boot data read request to the computing system 60 over the network 100. In some examples, the cable modem 14 sends the boot data read request to the DHCP server 64. In response to receiving the boot data read request from the cable modem 14, the computing system 60 assigns the IP address 36 and the configuration file identifier 38 (collectively “boot data 32”) to the cable modem 14. It should be understood that the configuration file identifier 38 includes a server address that tells the cable modem 14 where to find the configuration file 20. By way of non-limiting example, the configuration file identifier 38 may include an address associated with the configuration server 66. Subsequently, the computing system 60 (e.g., DHCP server 64) sends the boot data 32 to the cable modem 14 via the network 100, where it is stored in the memory 18 and/or in any other suitable data store of the cable modem 14.

Similarly, the computing system 60 also stores data associated with the cable modem 14 (e.g., cable modem data 30) in the data store 70 and/or in the memory 74 of the DHCP server 64. For instance, the DHCP server 64 may send a DHCP packet 88 to the data store 70, which, like the cable modem data 30, includes the assigned boot data 32 and the service profile data 34 associated with the cable modem 14.

The cable modem 14 receives the boot data 32 from the computing system 60. The cable modem 14 sends a configuration file read request to the computing system 60 over the network 100. The cable modem 14 sends the configuration file read request based on the configuration file identifier 38 (e.g., to the address identified in the boot data 32). In response to receiving the configuration file read request from the cable modem 14, the computing system 60 generates and provides the configuration file (e.g., configuration file 20) associated with the configuration file read request to the cable modem 14 via the network 100, where it is stored in the memory 18 and/or in any other suitable data store of the cable modem 14.

By way of non-limiting example, the configuration file identifier 38 provided to the cable modem 14 by the DHCP server 64 may be associated with the configuration server 66. In such instances, the cable modem 14 sends the configuration file read request to the configuration server 66. In response to receiving the configuration file read request, the configuration server 66 generates the configuration file 20. More particularly, the configuration server 66 generates a unique firmware file identifier (e.g., firmware file identifier 22) that is different from any existing firmware file identifier 92-1-92-N of any existing firmware file 90-1-90-N known to the computing system 60 (e.g., stored in the data store 70). For instance, in some implementations, the configuration server 66 may determine a randomized firmware file identifier. The configuration server 66 stores the unique firmware file identifier (e.g., firmware file identifier 22) in the configuration file 20. In addition to the firmware file identifier 22, the configuration server 66 also assigns and stores in the configuration file 20 a server address (e.g., firmware server address 24) that tells the cable modem 14 where to find the firmware file associated with the firmware file identifier 22. The cable modem 14 receives the configuration file 20 from the computing system 60. The cable modem 14 determines that the firmware file identifier 22 (e.g., unique firmware file identifier) included in the configuration file 20 does not match the stored firmware file identifier 28 that is associated with the stored firmware 26 (e.g., the current firmware version). Thus, from the perspective of the cable modem 14, the firmware file identifier 22 identifies an upgraded firmware file that the cable modem 14 should attempt to download and install. Hence, in response, the cable modem 14 generates and sends a firmware file request to the computing system 60 over the network 100 that includes the firmware file identifier 22.

The computing system 60 receives the firmware file request from the cable modem 14, and dynamically determines whether the current firmware version of the cable modem 14 (e.g., stored firmware file 26) is outdated. If the current firmware version of the cable modem 14 (e.g., stored firmware file 26) is outdated, the computing system 60 provides an updated firmware file 94 to the cable modem 14. If the current firmware version of the cable modem 14 (e.g., stored firmware file 26) is not outdated, the computing system 60 provides a firmware error message 98 to the cable modem 14. The cable modem 14 may then continue the boot process utilizing the existing firmware on the cable modem.

By way of non-limiting example, after generating the firmware file request, the cable modem 14 may send the firmware file request to the firmware server 68, which is the computing device identified by the firmware server address 24 included in the configuration file 20. Upon receipt, the firmware server 68 determines the current firmware version (e.g., stored firmware file 26) for the cable modem 14 based on the service profile data 34 (e.g., cable modem firmware data 44) stored in the data store 70 (e.g., via DHCP packet 88). The firmware server 68 determines a target firmware version for the cable modem 14 based on the service profile data 34 (e.g., vendor data 40 and cable modem identification data 42) stored in the data store 70 (e.g., via DHCP packet 88). It should be understood that, as used herein, “target firmware version” refers to the most up-to-date firmware version for the cable modem 14.

In response to determining the current firmware version for the cable modem 14 and the target firmware version for the cable modem 14, the firmware server 68 determines whether the current firmware version matches the target firmware version. If the current firmware version does not match the target firmware version, the firmware server 68 determines that the stored firmware 26 of the cable modem 14 is outdated. Conversely, if the current firmware version does match the target firmware version, the firmware server 68 determines that the stored firmware 26 of the cable modem 14 is not outdated (e.g., is up to date).

In response to determining the firmware of the cable modem 14 is outdated, the computing system 60 provides the updated firmware file 94 to the cable modem 14. For instance, by way of non-limiting example, in response to determining the current firmware version does not match the target firmware version, the firmware server 68 generates the updated firmware file 94 based on the target firmware version. The firmware server 68 names the updated firmware file 94 the same name as the updated firmware file identifier 96. The firmware server 68 provides the updated firmware file identifier 96, which corresponds to the unique and/or randomized firmware file identifier 22 provided to the cable modem 14 in the configuration file 20, to the updated firmware file 94. The firmware server 68 provides the updated firmware file 94 to the cable modem 14. The cable modem 14 stores the updated firmware file 94 and the updated firmware file identifier 96 in the memory 18 in place of the stored firmware file 26 and the stored firmware file identifier 28 and proceeds with initiating a reboot process, which is the same and/or similar to the boot processes described herein.

Conversely, in response to determining the firmware of the cable modem 14 is not outdated, the computing system 60 provides the firmware error message 98 to the cable modem 14. For instance, by way of non-limiting example, in response to determining the current firmware version matches the target firmware version, the firmware server 68 generates the firmware error message 98 and provides the firmware error message 98 to the cable modem 14. The cable modem 14 receives the firmware error message 98 proceeds with boot process utilizing the existing firmware file stored on the cable modem 14.

In this manner, the computing system 60 is operable to dynamically determine whether an upgraded firmware file exists for the cable modem 14 each time cable modem 14 enters the boot process.

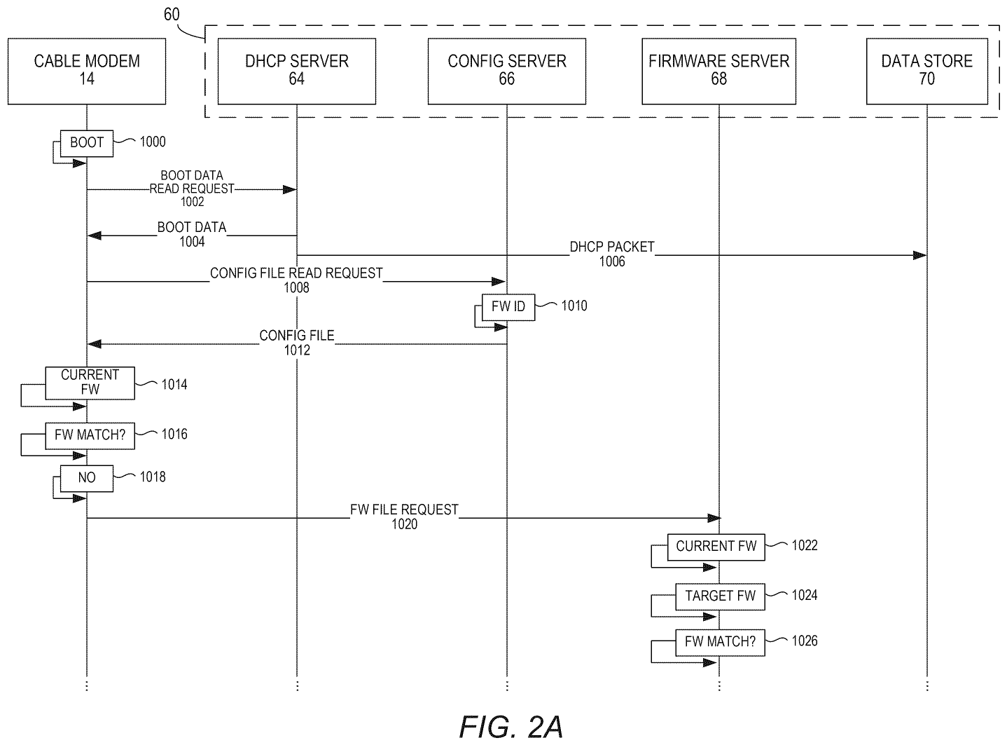

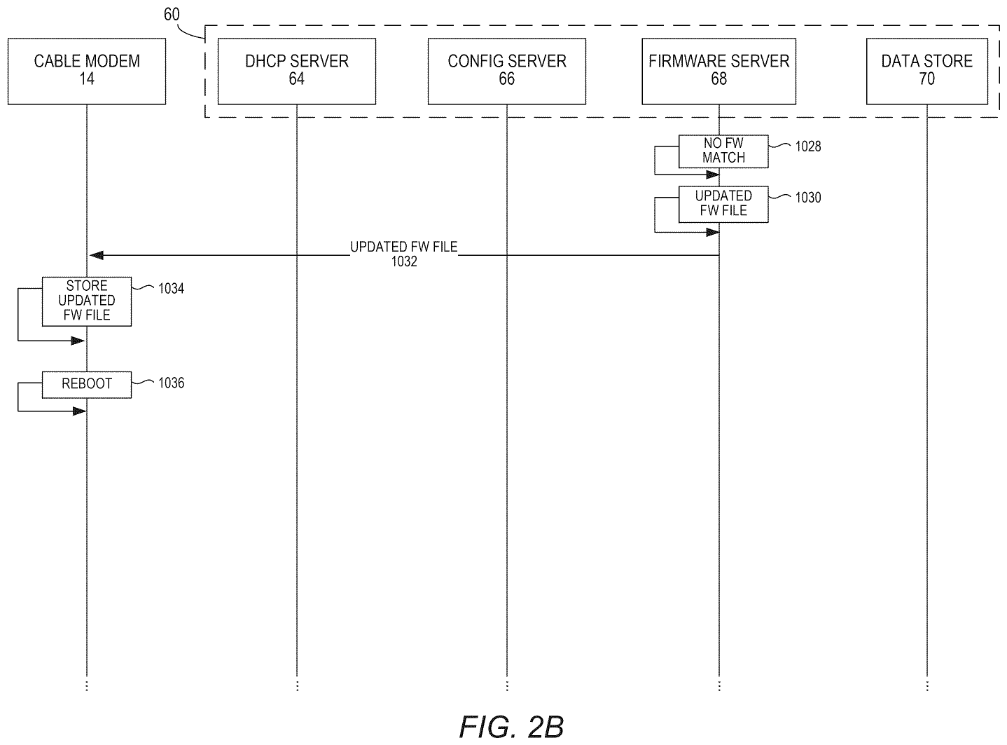

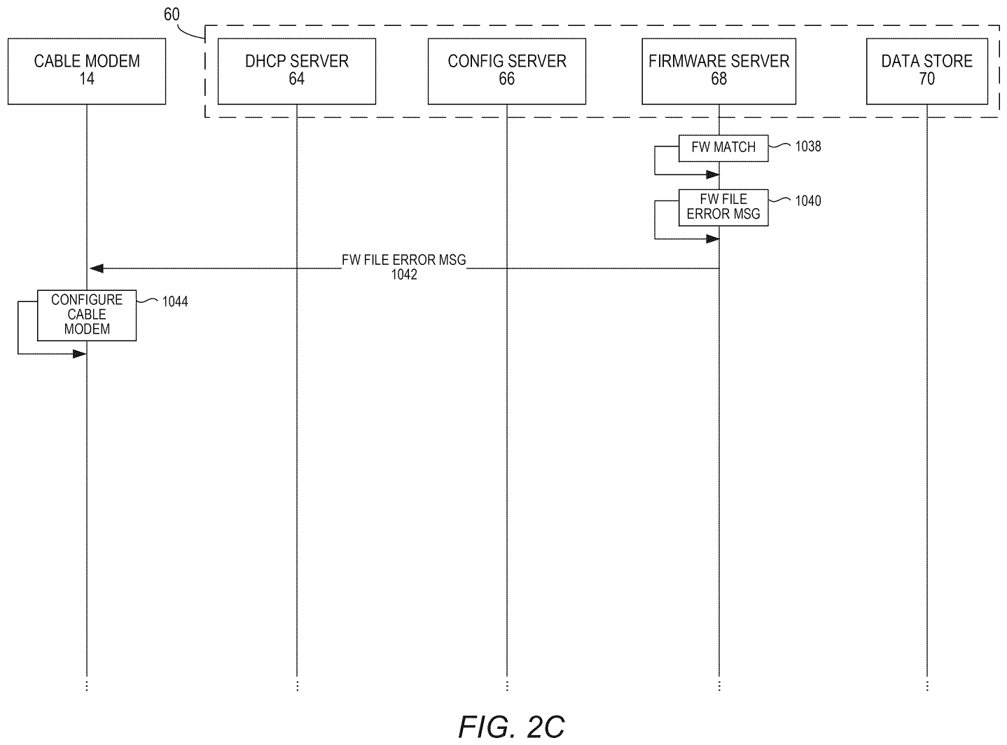

FIGS. 2A-2C are sequence diagrams illustrating messages communicated between and actions taken by certain components illustrated in FIG. 1 to dynamically upgrading a modem according to one implementation of the present disclosure. FIGS. 2A-2C will be discussed in conjunction with FIG. 1.

The cable modem 14 initiates a boot process (FIG. 2A, step 1000). The cable modem 14 provides a boot data read request to the DHCP server 64 of the computing system (FIG. 2A, step 1002). The DHCP server 64 receives the boot data read request from the cable modem 14 and provides boot data 32, including the IP address 36 and the configuration file identifier 38, to the cable modem (FIG. 2A, step 1004).

The DHCP server 64 may also provide data associated with the cable modem 14 (e.g., DHCP packet 88) to the data store 70 of the computing system 60 for storage (FIG. 2A, step 1006). In some implementations, the data associated with the cable modem 14 stored at the data store 70 includes service profile data 34 associated with the cable modem 14, such as, by way of non-limiting example, vendor data 40 associated with a vendor of the cable modem 14, cable modem identification data 42 (e.g., model number, subscribed data rate data, etc.), cable modem firmware data 44 (e.g., associated with the stored firmware file 26 of the cable modem 14), and the like.

The cable modem 14 receives the boot data 32 from the computing system 60. The cable modem 14 sends a configuration file read request to the configuration server 66 based on the configuration file identifier 38 (FIG. 2A, step 1008). The configuration server 66 generates a unique firmware file identifier (e.g., firmware file identifier 22) that is different from existing firmware file identifiers 92-1-92-N of existing firmware files 90-1-90-N and stores the unique firmware file identifier (e.g., firmware file identifier 22) in the configuration file 20 (FIG. 2A, step 1010). The configuration server 66 provides the configuration file 20, which includes the firmware server address 24 and the firmware file identifier 22 that does not match an existing firmware file identifier 92-1-92-N of any existing firmware file 90-1-90-N provided by the computing system 60 to cable modems, to the cable modem 14 (FIG. 2A, step 1012).

The cable modem 14 receives the configuration file 20. The cable modem 14 determines a current firmware version of the cable modem 14, which corresponds to the stored firmware file 26, based on the stored firmware file identifier 28 stored in the memory 18 (FIG. 2A, step 1014). The cable modem 14 determines whether the stored firmware file identifier 28 matches the unique firmware file identifier (e.g., firmware file identifier 22) received in the configuration file 20 (FIG. 2A, step 1016). Because the firmware file identifier 22 is unique, the cable modem 14 determines that the firmware file identifier 22 does not match the existing stored firmware file identifier 28 of the stored firmware file 26 (FIG. 2A, step 1018). In response, the cable modem 14 generates a firmware file request, which includes the firmware file identifier 22, and sends the firmware file request to the firmware server 68 that was identified by the firmware server address 24 of the configuration file 20 (FIG. 2A, step 1020).

The firmware server 68 receives the firmware file request, and determines the current firmware version running on the cable modem 14 (e.g., stored firmware file 26) based at least in part on the cable modem firmware data 44 of the service profile data 34 stored in the data store 70 (e.g., via DHCP packet 88) (FIG. 2A, step 1022). The firmware server 68 determines a target firmware version for the cable modem 14 based at least in part on the cable modem identification data 42 and the vendor data 40 of the service profile data 34 stored in the data store 70 (e.g., via DHCP packet 88) (FIG. 2A, step 1024). The firmware server 68 determines, based on the current firmware version and the target firmware version, whether the current firmware version matches the target firmware version (FIG. 2A, step 1026).

Referring now to FIG. 2B, the firmware server 68 determines that the current firmware version does not match the target firmware version, and thus, that the stored firmware file 26 of the cable modem 14 is outdated (FIG. 2B, step 1028). The firmware server 68 generates the updated firmware file 94 and provides the updated firmware file identifier 96, which corresponds to the firmware file identifier 22 provided in the configuration file 20, to the updated firmware file 94 (FIG. 2B, step 1030). The firmware server 68 provides the updated firmware file 94 to the cable modem 14 (FIG. 2B, step 1032). The cable modem 14 receives the updated firmware file 94 from the firmware server 68 and stores the updated firmware file 94 and the updated firmware file identifier 96 in a data store (e.g., memory 18) of the cable modem 14 (FIG. 2B, step 1034). The cable modem 14 initiates a reboot process (FIG. 2B, step 1036).

Following the reboot, the cable modem 14 may return to FIG. 2A, step 1004 and proceed with the configuration processes described above. By way of non-limiting example, the cable modem 14 may provide a second boot data read request to the DHCP server 64 (e.g., FIG. 2A, step 1002). The DHCP server 64 may provide the boot data 32, including a second configuration file identifier 38, to the cable modem 14 (e.g., FIG. 2A, step 1004). The DHCP server 64 may provide a second DHCP packet 88 to the data store 70 (e.g., FIG. 2A, step 1006). The cable modem 14 receives the boot data 32. The cable modem 14 may send a second configuration file read request to the configuration server 66 (e.g., FIG. 2A, step 1008), and the configuration server 66 may determine a second unique/randomized firmware file identifier (e.g., firmware file identifier 22) that is different from the first unique/randomized firmware file identifier determined at FIG. 2A, step 1010. The configuration server 66 provides a second configuration file 20 to the cable modem 14, which includes the second unique/randomized firmware file identifier (e.g., FIG. 2A, step 1012). The cable modem 14 receives the second configuration file 20 and determines whether the current firmware version of the cable modem 14 corresponds to the stored firmware file 26 in the same manner as described above (e.g., FIG. 2A, step 1014). Because the second firmware file identifier 22 included in the configuration file 20 is unique, the cable modem 14 proceeds with generating and sending a second firmware file request to the firmware server 68 (e.g., FIG. 2A, steps 1016-1020). The firmware server 68 determines whether the stored firmware file 26 of the cable modem 14 is outdated in the same manner as described above (e.g., FIG. 2A, steps 1022-1026). However, due to the updated firmware file 94 being provided to the cable modem 14 immediately prior to the reboot process (e.g., FIG. 2B, steps 1028-1036), the firmware server 68 will instead proceed from FIG. 2A, step 1026 to FIG. 2C, step 1038.

Referring now to FIG. 2C, in response to determining the current firmware version matches the target firmware version, the firmware server 68 determines the stored firmware file 26 of the cable modem 14 is not outdated (FIG. 2C, step 1038). The firmware server 68 generates a firmware file error message (FIG. 2C, step 1040) and provides the firmware file error message to the cable modem 14 (FIG. 2C, step 1042). The cable modem 14 receives the firmware file error message and proceeds with the boot process of the cable modem 14 (FIG. 2C, step 1044).

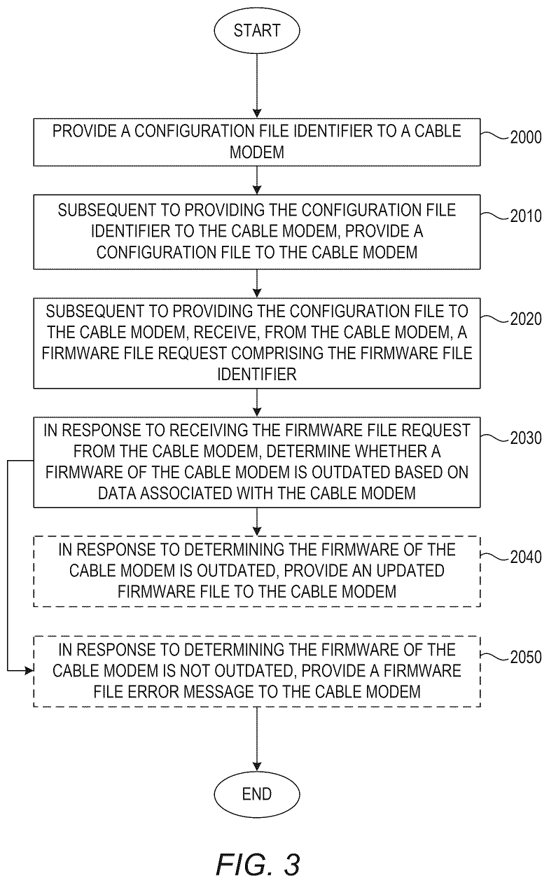

FIG. 3 is a flowchart of a method for dynamically providing updated firmware files to a cable modem according to one implementation of the present disclosure. FIG. 3 will be discussed in conjunction with FIG. 1. The computing system 60, which includes one or more computing devices, provides the configuration file identifier to the cable modem 14 (FIG. 3, block 2000). Subsequently, the computing system 60 provides the configuration file 20, which includes the firmware file identifier 22 that does not match an existing firmware file identifier 92-1-92-N of any existing firmware file 90-1-90-N provided by the computing system 60 to cable modems, to the cable modem 14 (FIG. 3, block 2010). Subsequently, the computing system 60 receives the firmware file request from the cable modem 14 that includes the firmware file identifier 22 (FIG. 3, block 2020). In response, the computing system 60 determines whether the firmware of the cable modem 14 (e.g., stored firmware file 26) is outdated based on data associated with the cable modem (e.g., DHCP packet 88) (FIG. 3, block 2030). When the firmware of the cable modem 14 is outdated, the computing system 60 may provide the updated firmware file 94 to the cable modem 14 (FIG. 3, block 2040). When the firmware of the cable modem 14 is not outdated, the computing system 60 may provide the firmware file error message to the cable modem 14 (FIG. 3, block 2050).

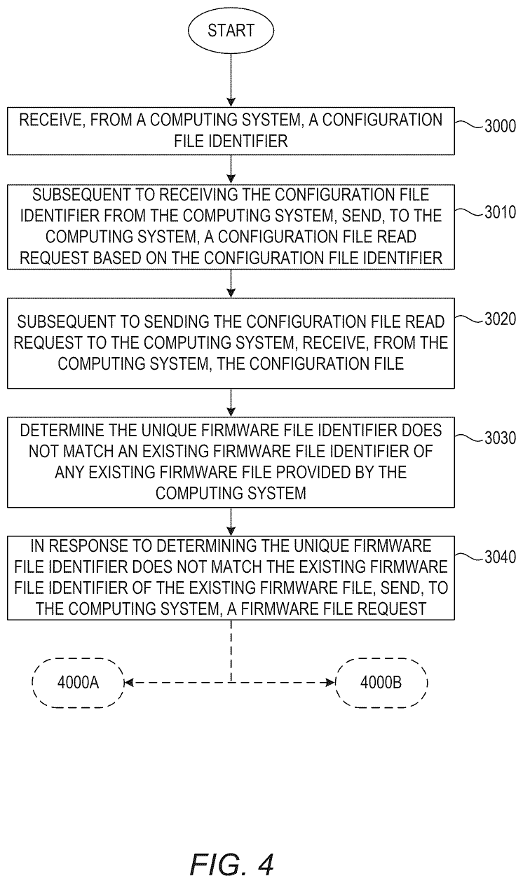

FIG. 4 is a flowchart of a method for dynamically configuring a cable modem according to one implementation of the present disclosure. FIG. 4 will be discussed in conjunction with FIG. 1. The cable modem 14 receives the configuration file identifier 38, which corresponds to the configuration file 20 for the cable modem 14, from the computing system 60 (FIG. 4, block 3000). Subsequently, the cable modem 14 sends the configuration file read request to the computing system 60 based on the configuration file identifier 38 (FIG. 4, block 3010). Subsequently, the cable modem 14 receives the configuration file 20, which includes a unique firmware file identifier 22, from the computing system 60 (FIG. 4, block 3020). The cable modem 14 determines the unique firmware file identifier 22 does not match an existing firmware file identifier of any existing firmware file (e.g., stored firmware identifier 28 of stored firmware 26) provided by the computing system 60 (FIG. 4, block 3030). In response, the cable modem 14 sends a firmware file request to the computing system 60 (FIG. 4, block 3040).

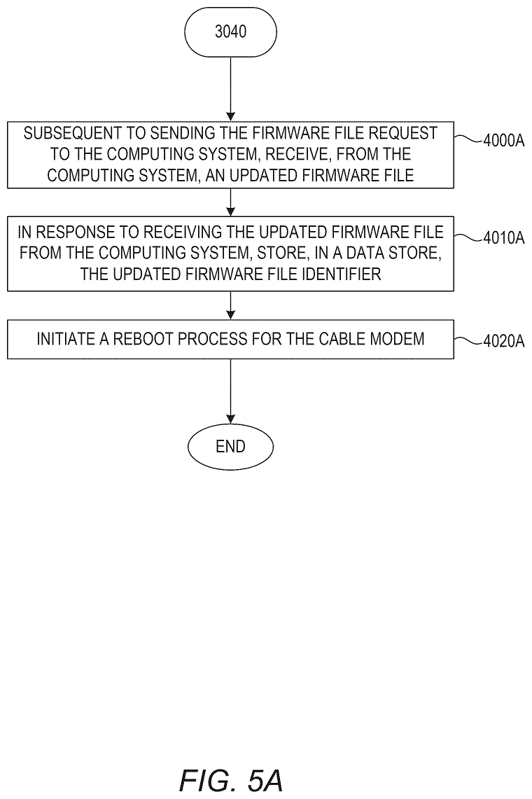

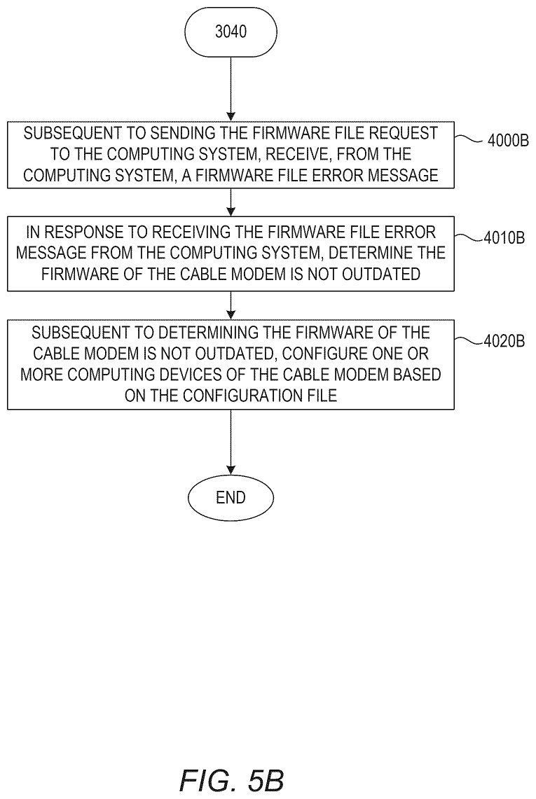

FIG. 5A is a flowchart of the method of FIG. 4 for dynamically configuring the cable modem according to one implementation of the present disclosure. FIG. 5A will be discussed in conjunction with FIG. 1 and FIG. 4. In some implementations, subsequent to sending the firmware file request to the computing system 60 (FIG. 4, block 3040), the cable modem 14 may receive an updated firmware file 94, which includes an updated firmware file identifier 96 that matches the firmware file identifier 22 provided in the configuration file 20, from the computing system 60 (FIG. 5A, block 4000A). In response, the cable modem 14 stores the updated firmware file identifier 96 in the data store (e.g., memory 18) of the cable modem 14 (FIG. 5A, block 4010A), and the cable modem 14 initiates a reboot process (FIG. 5A, block 4020A).

FIG. 5B is a flowchart of the method of FIG. 4 for dynamically configuring the cable modem according to one implementation of the present disclosure. FIG. 5B will be discussed in conjunction with FIG. 1 and FIG. 4. In some implementations, subsequent to sending the firmware file request to the computing system 60 (FIG. 4, block 3040), the cable modem 14 may receive a firmware file error message from the computing system 60 (FIG. 5B, block 4000B). In response, the cable modem 14 determines its firmware (e.g., stored firmware file 26) is not outdated (FIG. 5B, block 4010B), and, subsequently, proceeds with the boot process of the cable modem 14 based on the configuration file 20 (FIG. 5B, block 4020B).

Individuals will recognize improvements and modifications to the preferred examples of the disclosure. All such improvements and modifications are considered within the scope of the concepts disclosed herein and the claims that follow.

What is claimed is:

1. A method, comprising:
providing, by a computing system comprising one or more computing devices, a configuration file identifier to a cable modem;
subsequent to providing the configuration file identifier to the cable modem, providing, by the computing system, a configuration file to the cable modem, the configuration file comprising a firmware file identifier that does not match an existing firmware file identifier of any existing firmware file provided by the computing system to cable modems;
receiving, by the computing system from the cable modem, a firmware file request comprising the firmware file identifier;
in response to receiving the firmware file request from the cable modem, determining, by the computing system, whether a firmware of the cable modem is outdated based on data associated with the cable modem; and
in response to determining the firmware of the cable modem is outdated, providing, by the computing system, an updated firmware file to the cable modem.

2. The method of claim 1, further comprising:
in response to determining the firmware of the cable modem is not outdated, providing, by the computing system, a firmware file error message to the cable modem.

3. The method of claim 1, wherein providing the configuration file identifier to the cable modem comprises:
receiving, by the computing system from the cable modem, a boot data read request;
providing, by the computing system to the cable modem, boot data that comprises an IP address for the cable modem and the configuration file identifier; and
storing, by the computing system, the data associated with the cable modem in a data store of the computing system, the data associated with the cable modem comprising the boot data and service profile data associated with the cable modem.

4. The method of claim 3, wherein providing the configuration file to the cable modem comprises:
receiving, by the computing system from the cable modem, a configuration file read request;
generating, by the computing system, the firmware file identifier associated with the firmware file, the firmware file identifier being different from existing firmware file identifiers associated with existing firmware files provided by the computing system to cable modems; and
storing, by the computing system in the configuration file, the firmware file identifier associated with the firmware file.

5. The method of claim 3, wherein providing the configuration file to the cable modem comprises:
receiving, by the computing system from the cable modem, a configuration file read request;
determining, by the computing system, a randomized firmware file identifier for the cable modem, the randomized firmware file identifier corresponding to the firmware file identifier; and
providing, by the computing system to the cable modem, the configuration file, the configuration file comprising the randomized firmware file identifier.

6. The method of claim 5, wherein determining whether the firmware of the cable modem is outdated comprises:
subsequent to receiving the firmware file request from the cable modem, determining, by the computing system, a current firmware version for the cable modem based on the service profile data;
determining, by the computing system, a target firmware version for the cable modem based on the service profile data; and
determining, by the computing system, whether the current firmware version matches the target firmware version.

7. The method of claim 6, wherein the service profile data comprises:
vendor data associated with a vendor of the cable modem;
cable modem identification data comprising a model number of the cable modem and data associated with a subscribed data rate of the cable modem; and
cable modem firmware data associated with the firmware of the cable modem.

8. The method of claim 7, wherein determining the current firmware version for the cable modem comprises:
determining, by the computing system, the current firmware version running on the cable modem based at least in part on the cable modem firmware data of the service profile data.

9. The method of claim 7, wherein determining the target firmware version for the cable modem comprises:
determining, by the computing system, the target firmware version for the cable modem based at least in part on the cable modem identification data and the vendor data of the service profile data.

10. The method of claim 6, further comprising:
in response to determining the current firmware version does not match the target firmware version, determining, by the computing system, the firmware of the cable modem is outdated; and
in response to determining the current firmware version matches the target firmware version, determining, by the computing system, the firmware of the cable modem is not outdated.

11. The method of claim 10, wherein providing the updated firmware file to the cable modem comprises:
generating, by the computing system, the updated firmware file based on the target firmware version;
providing, by the computing system, the randomized firmware file identifier to the updated firmware file; and
providing, by the computing system, the updated firmware file to the cable modem.

12. The method of claim 11, wherein the randomized firmware file identifier is a first randomized firmware file identifier, the method further comprising:
subsequent to providing the updated firmware file to the cable modem, receiving, by the computing system from the cable modem, a second configuration file read request;
determining, by the computing system, a second randomized firmware file identifier for the cable modem, the second randomized firmware file identifier being different from the first randomized firmware file identifier; and
providing, by the computing system, a second configuration file to the cable modem, the second configuration file comprising the second randomized firmware file identifier.

13. The method of claim 12, further comprising:
subsequent to providing the second configuration file to the cable modem, receiving, by the computing system from the cable modem, a second firmware file request;
determining, by the computing system, the current firmware version for the cable modem matches the target firmware version associated with the updated firmware file;
in response to determining the current firmware version for the cable modem matches the target firmware version associated with the updated firmware file, determining, by the computing system, the firmware of the cable modem is not outdated; and
in response to determining the firmware of the cable modem is not outdated, providing, by the computing system, a firmware file error message to the cable modem.

14. The method of claim 10, further comprising:
in response to determining the current firmware version matches the target firmware version, generating, by the computing system, a firmware file error message; and
providing, by the computing system, the firmware file error message to the cable modem.

15. A method, comprising:
receiving, by a cable modem, a configuration file identifier from a computing system, the configuration file identifier corresponding to a configuration file for the cable modem;
sending, by the cable modem to the computing system, a configuration file read request based on the configuration file identifier;
receiving, by the cable modem from the computing system, the configuration file, the configuration file comprising a unique firmware file identifier;
determining, by the cable modem, the unique firmware file identifier does not match an existing firmware file identifier of any existing firmware file provided by the computing system; and
in response to determining the unique firmware file identifier does not match the existing firmware file identifier of any existing firmware file, sending, by the cable modem, a firmware file request to the computing system.

16. The method of claim 15, wherein determining the unique firmware file identifier does not match the existing firmware file identifier of any existing firmware file comprises:
determining, by the cable modem, a current firmware version of the cable modem based on a stored firmware file identifier stored in a data store of the cable modem, the current firmware version corresponding to the firmware of the cable modem;
determining, by the cable modem, whether the stored firmware file identifier matches the unique firmware file identifier received in the configuration file from the computing system; and
in response to determining the stored firmware file identifier does not match the unique firmware file identifier received in the configuration file, generating, by the cable modem, the firmware file request.

17. The method of claim 15, further comprising:
receiving, by the cable modem from the computing system, an updated firmware file, the updated firmware file comprising an updated firmware file identifier corresponding to the unique firmware file identifier;
storing, by the cable modem, the updated firmware file identifier in a data store of the cable modem; and
initiating, by the cable modem, a reboot process for the cable modem.

18. The method of claim 15, further comprising:
receiving, by the cable modem from the computing system, a firmware file error message;
determining, by the computing system, based on the firmware file error message, that the firmware of the cable modem is not outdated; and
proceeding, by the cable modem, with a boot process of the cable modem.

19. A computing system, comprising:
one or more computing devices operable to:
provide a configuration file identifier to a cable modem;
subsequently, provide a configuration file to the cable modem, the configuration file comprising a firmware file identifier that does not match an existing firmware file identifier of any existing firmware file provided by the computing system to cable modems;
receive a firmware file request comprising the firmware file identifier from the cable modem;
in response to receiving the firmware file request, determine whether a firmware of the cable modem is outdated based on data associated with the cable modem; and
in response to determining the firmware of the cable modem is outdated, provide an updated firmware file to the cable modem.

20. The computing system of claim 19, wherein the one or more computing devices are further operable to:
in response to determining the firmware of the cable modem is not outdated, provide a firmware file error message to the cable modem.
